(19) United States
(12) Patent Application Publication
(10) Pub. No.: US 2014/0284204 A1
(43) Pub. Date: Sep. 25, 2014

(54) METHOD AND DEVICE FOR IONIZING PARTICLES OF A SAMPLE GAS GLOW

(71) Applicants: AIRMODUS OY, Helsinki (FI); UNIVERSITY OF HELSINKI, Helsingin Yliopisto (FI)

(72) Inventors: Mikko SIPILÄ, Helsinki (FI); Joonas VANHANEN, Helsinki (FI)

(21) Appl. No.: 13/849,171

(22) Filed: Mar. 22, 2013

(51) Int. Cl. G01N 27/64

(52) U.S. Cl. CPC G01N 27/64
USPC 204/157.44; 422/186.29; 204/157.63; 204/157.64

(57) ABSTRACT

A device for ionizing particles (molecules or clusters) of a sample gas flow comprises a first flow tube for providing the sample gas flow, and a generator for producing reagent primary ions from particles of candidate reagent gas flow at a primary ion production region. The device also has an interaction region for introducing the reagent ions into the sample gas flow in order to arrange interaction between the reagent primary ions and the particles of the sample gas flow, thereby producing sample gas ions to be delivered to a detector. The generator for producing reagent primary ions is a non-radioactive soft X-ray radiation source.

### TECHNICAL FIELD OF THE INVENTION

The present invention relates to a method and device for ionizing particles of a sample gas flow before a detector, such as a mass spectrometer, in order to determine properties, such as masses or concentrations, of gas phase samples or especially molecules or clusters, for example gas phase bases or acids samples.

### BACKGROUND OF THE INVENTION

An accurate mass spectrometry methods for determining of properties of gas phase samples are in very important role e.g. in atmospheric studies, such as studying e.g. roles of different chemical substances, such as ammonia, amines, sulphuric acid and oxidized organics, in atmospheric nanoparticle formation. Especially there is a need for better known of low concentrations and variability of atmospheric amines and highly oxidized organics as well as also many other bases and acids.

However, measurement of trace amounts of gaseous compounds for example from air is extremely difficult, as their concentration is minimal compared to the total air molecule concentration, and due to the large variety of the different gases compounds and their isotopes. However, some of these molecules have a significant effect on the air chemistry and aerosol formation, even in small amounts. Therefore exact measurements are needed for instance in atmospheric aerosol research.

Very often gas phase samples are analysed by a mass spectrometer, but also other detecting devices can be used, such as IMS-device (Ion Mobility Spectrometry) or DMA-device (Differential Mobility Analyzers). The mass spectrometer is detecting the mass to charge ratio of an ion or ion cluster, whereas IMS and DMA devices are based on the electrical mobility of the sample particles. As majority of sample particles, such as airborne molecules and clusters are initially neutral, they need to be charged before a measurement.

One exemplary method to charge the sample particles, such as molecules and clusters, before the measurement and thereby provide an ion flow of sample constituents is chemical ionizing (CI) of the sample constituents using, e.g., a proton transfer reaction or sample constituent clustering with the primary ion, or in other words using an ion-molecule reaction.

Few methods for producing primary ions for charging the molecules e.g. in mass spectrometry are known from the prior art, such as using a radioactive source or a corona charger. However, there are some drawbacks related to the prior art solution. Radioactive sources can be hazardous if used improperly, especially together with acids in a chemical ionization inlet (CI-inlet). In addition they are very difficult to access and dispose of Furthermore for example maintenance of the charger with the radioactive source is very demanding task and needs a professional personal to repair the device due to radioactivity. Also bureaucracy related to usage, selling and transportations are challenging. All the previous rises the operating costs of the charger with the radioactive source.

In corona charging a high voltage on a needle tip is used to produce ions via corona discharges. However, the usage of corona discharge is very violent ionization method which can break for example some of the weakly bound molecules or clusters in the vicinity. In oxygen-containing environment it produces a lot of ozone, and possibly also oxygen and hydroxyl radicals, etc., which can react with the molecules in the gas sample and/or produce contaminants, which mess the spectrum and makes it harder to identify the wanted sample compounds. It can also produce ions, including, for example HSO4−, in presence of trace levels of SO2. These artificial HSO4− ions interfere with the HSO4− ions chemically ionized by extracting a proton from H2SO4 (sulphuric acid) molecule thus influencing the sulphuric acid detection by CI-MS method.

### SUMMARY OF THE INVENTION

An object of the present invention is to alleviate and eliminate the problems relating to the known prior art. Especially the object of the present invention is to provide a method and device for ionizing particles of a sample gas flow for detection of extremely low concentrations of gas phase constituents, comprising bases, acids and oxygenated organics.

In certain aspects, the present invention is directed at a method for ionizing particles of a sample gas flow by an ionizer, wherein the particles comprise molecules or clusters, and the method can comprise providing the sample gas flow to flow through an interaction region, producing reagent primary ions from particles of candidate reagent gas flow, introducing said reagent primary ions with the sample gas flow in said interaction region in order to arrange interaction between the reagent ions and the particles of the sample gas flow, thereby producing sample gas ions to be delivered to a detector, wherein said reagent ions are produced by ionising said particles of the candidate reagent gas flow using soft X-ray radiation from a non-radioactive X-ray source.

In certain aspects, the present invention is directed at a device for ionizing particles of a sample gas flow, the particles comprising molecules or clusters, the device comprising a first flow tube for providing the sample gas flow, a generator for producing reagent primary ions from particles of candidate reagent gas flow essentially at a primary ion production region, an interaction region for introducing said reagent ions into the sample gas flow in order to arrange interaction between the reagent primary ions and the particles of the sample gas flow, thereby producing sample gas ions to be delivered to a detector, wherein the generator for producing reagent primary ions by ionising said particles of the candidate reagent gas flow is a non-radioactive soft X-ray radiation source.

According to an embodiment of the present invention, particles, such as molecules or clusters, of a sample gas flow is ionized by an ionizer so that properties of the sample gas flow particles can be determined. According to the embodiment reagent (primary) ions are produced from particles of candidate reagent gas flow, which may comprise for example nitrate NO3−, bisulfate, HSO4−, protonated ammonia, amines, alcohols or acetone.

In addition according to the embodiment the reagent ions are introduced with the sample gas flow in an interaction region in order to arrange interaction between the reagent ions and the particles of the sample gas flow thereby producing sample gas ions, which can be delivered for example to a detector. In the interaction region the produced (preliminary) ions are interacting with the molecules or clusters or other particles of the sample gas flow thereby ionizing said sample gas particles (via charge transfer). In addition according to the embodiment the reagent ions are produced by ionising said particles of the candidate (primary) reagent gas flow using soft X-ray radiation, which is produces by a non-radioactive X-ray source.

The sample gas flow comprises advantageously particles to be determined, such as atmospheric bases or acids. It may also comprise any interfering constituents other than said sample particles to be determined. The sample particles comprise for example molecules or clusters, and the sample gas flow is advantageously in an atmospheric pressure.

The energy of the used soft X-ray photons is advantageously in a range of 1-10 keV, most advantageously about 1-5 keV.

In the embodiment also a sheath flow is arranged to flow at least through the primary ion production region and interaction region between the sample gas flow and wall structure of the ionizer, and thereby preventing or at least minimizing any interactions of the sample and/or reagent ions flow with the wall structure of the ionizer. The sheath flow is advantageously essentially laminar flow, and it comprises e.g. clean air or nitrogen, with small amounts of reagent gas molecules, e.g. nitric acid, sulphuric acid, ammonia, amines, alcohols, or acetone.

According to an embodiment the sample gas flow and candidate (primary) reagent gas flow is configured to flow essentially concentrically. The trajectory of the produced reagent ions is configured to bend inward and towards the sample gas flow at the charge transfer interaction region so that the reagent ions can interact with said sample gas flow particles and thereby for sample gas ions flow before any detector. The trajectory of the produced reagent ions can be achieved for example by using an electric field for attracting or repulsing said ions, and/or by using flow current guiding means, such as a deflector, wing or throttle, like a venturi tube, for example.

According to an embodiment the candidate reagent gas flow may comprise e.g. nitrate [NO3−], bisulfate, HSO4−, protonated ammonia, amines, alcohols or acetone. Anyhow these are only example and it should be understood that the composition of the candidate reagent gas flow may vary depending of the sample particles to be ionized. For example NO3− is a very selective for charging a certain sample gas flow particles, as well as also ammonium NH4+ for charging other sample particles. NO3− is a very selective for charging for example H2SO4 [Sulfuric acid], MSA [methane sulfonic acid], H2SO4+ amine clusters, highly oxidized organic molecules and their clusters, whereas NH4+can be used for charging amines, as an example (not naturally limiting only to those). The ionizing method of the invention may be achieved very selective by selecting a certain candidate reagent gas. For example a certain candidate reagent gas flow may be selected for producing certain reagent ions and thereby providing selective compound charging in the charge transfer interaction region in order to arrange charge transfer interaction between the reagent ions and certain desired particles of the sample gas flow (depending on the particles of interest).

The present invention offers remarkable advantages over the known prior art solutions. For example the non-radioactive soft X-ray radiation source for ionising the particles of the candidate (primary) reagent gas flow is a very safe device for users, because it does not contain any radioactive material. Thus it is also quite easy to produce and ship, because there is no need for demanding shielding systems or bureaucracy. Furthermore the X-ray radiation source can simply be switched ON and OFF e.g. for testing the functioning of the instrument or during maintenance. In addition the X-ray source radiation (i.e. low energy gamma radiation) does not produce contaminants (to large extent as corona does) which disturb the identification of the molecules.

Moreover, because the used X-ray radiation is soft radiation (energy is typically in the range of ˜1-10 keV), it does not, to high extent, break molecules and clusters to be determined and thereby disturb the measurement.

In addition the concept of the invention can be easily used for selective measurements, which means that the sample particles (gas molecules or clusters) to be measured can be determined by choosing an appropriate reagent (primary) ion composition for interacting with said sample particles, i.e. the ions can be produced for compound selective charging of the molecules of interest. For example when using NO3− as a primary reagent ion as described above, certain sample particles can be ionized and thereby determined. This feature is called as a Selective Ion Chemical Ionization, and it has remarkable advantages, such as for focusing only to desired sample particles and thereby minimizing possible disturbing effects of other particles since they are not charged. Thus the invention enables getting a clean mass spectrum from where the exact mass and concentration of the wanted compound can be extracted. The Selective Ion Chemical Ionization can be used for example to the detection of strong acids—including e.g. sulphuric acid and methyl sulfonic acid—strong bases—including e.g. ammonia and amines—clusters of those, oxidized organic compounds, as an example and not limiting only to those.

In addition the invention offers the possibility to measure accurately e.g. concentrations of atmospheric bases or acids, which proportions of the all constituents of whole atmospheric gas constituents in the sample gas flow is very minimal. In addition the invention enables online measurement and high time resolution even at the same time. Moreover the measurements can be done in atmospheric pressure, which increases (when compared to the prior art solutions with very low measuring pressure) the collision rate of the reagent ions with the sample particles and thereby makes the ionization process much effective so that even an order of ppq particle concentrations can be measured [ppq, parts-per-quadrillion, 10⁻¹⁵].

The exemplary embodiments presented in this text are not to be interpreted to pose limitations to the applicability of the appended claims. The verb “to comprise” is used in this text as an open limitation that does not exclude the existence of also unrecited features. The features recited in depending claims are mutually freely combinable unless otherwise explicitly stated.

The novel features which are considered as characteristic of the invention are set forth in particular in the appended claims. The invention itself, however, both as to its construction and its method of operation, together with additional objects and advantages thereof, will be best understood from the following description of specific example embodiments when read in connection with the accompanying drawings.

### BRIEF DESCRIPTION OF THE DRAWINGS

Next the invention will be described in greater detail with reference to exemplary embodiments in accordance with the accompanying drawings, in which:

FIG. 1 illustrates a principle of an exemplary device for ionizing particles of a sample gas flow according to an advantageous embodiment of the invention.

### DETAILED DESCRIPTION OF THE DRAWINGS

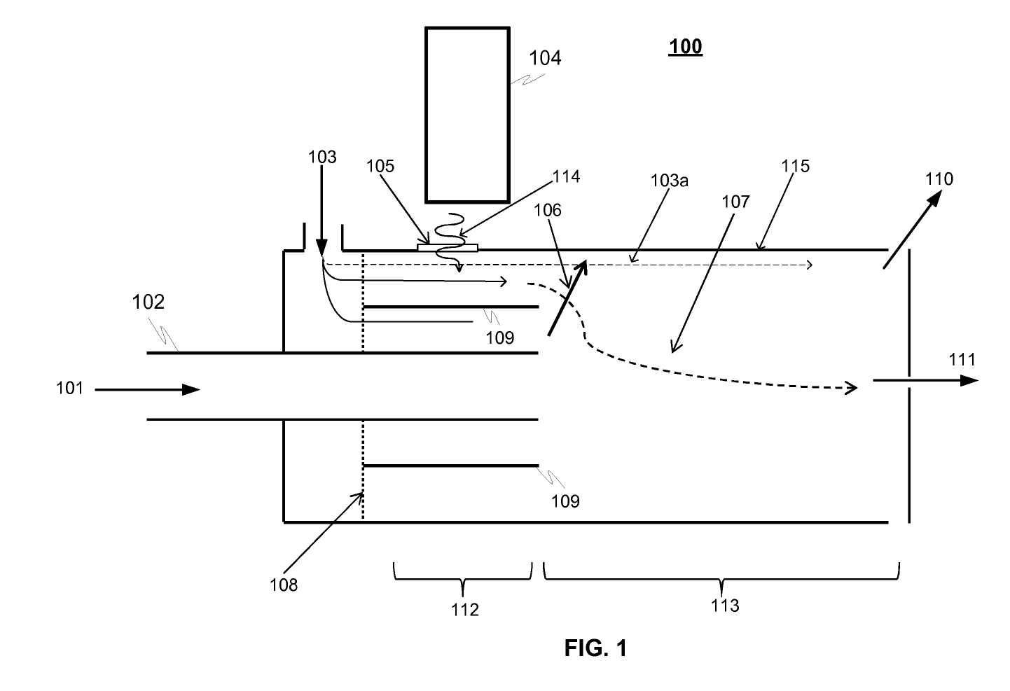

FIG. 1 illustrates a principle of an exemplary device 100 for ionizing particles of a sample gas flow according to an advantageous embodiment of the invention. The device 100 comprises an inlet, which can be in the form of a first flow tube 102 for providing the sample gas flow 101. In addition the device comprises a generator 104 for producing reagent primary ions 107 from particles (molecules) of candidate reagent gas flow 103 advantageously at a primary ion production region 112 (region where the X-ray ionizing radiation ionizes the candidate reagent gas flow 103).

The device also has an interaction region 113 for introducing said reagent primary ions 107 into the sample gas flow 101 in order to arrange charge transfer between the primary ions and particles of the sample gas flow to be determined and thereby producing sample gas ions 111 of the particles interested and to be delivered to a detector. The interaction is typically ion—molecule or ion—cluster interaction.

According to the embodiments of the invention the generator 104 for producing reagent primary ions 107 is a non-radioactive soft X-ray radiation source 104. Advantageously the device or the generator is provided with a switch for operating the X-ray radiation source between an operation mode and off mode [ON/OFF]. The energy of the soft X-ray photons generated by the X-ray radiation source is in a range of 1-10 keV, most advantageously about 1-5 keV, as an example.

The device comprises also a second flow tube 109 for guiding the candidate reagent gas flow 103 for interaction with the soft X-ray radiation 114 at the primary ion production region 112. The second flow tube 109 may also guide the produced reagent primary ions flow 107. The first 102 and second 109 tubes may advantageously be arranged essentially concentrically in order to arrange said sample gas flow and candidate reagent gas flow to flow essentially concentrically at the primary ion production region.

The device may also comprise a shielded area 105 between the X-ray source 104 and the flowing media 103 (such as candidate reagent gas flow 103 and sheath flow 103a) for shielding the X-ray source about any possible contamination of sample or other particles presented in the flow tubes. The shielded area 105 comprises advantageously beryllium, aluminum or glass.

The device is further configured to bend the trajectory 107 of the produced reagent primary ions inward and towards the sample gas flow 101. The bending effect can be implemented for example by the means of electrode and/or a flow current guiding means, such as a deflector, wing or throttle, like a venturi tube (not shown). According to an embodiment the electrode may be a separate electrode or it may be implemented via the second flow tube 109, which may comprise at least portion of it to function as an electrode and generating an electric field 106 and is thereby configured to bend the trajectory 107 of the produced reagent primary ions inward and towards the sample gas flow 101. The device comprises advantageously an adjusting means for adjusting the polarity and/or voltage difference between the second flow tube 109 and the device outer wall 115 or the first flow tube 102 depending for example of the reagent primary ions, geometry of the device as well as flow rates of the flowing particles, for example. The voltage may be, as an example, in the range of −100-200 V, advantageously about −140 V for example when NO3− ions are used.

In addition the device may comprise also a laminarizer 108 for producing an essentially laminar sheath flow 103a between the reagent primary ions flow 107 and structure 115 of the device 100 and/or said second tube 109 in order to prevent or minimize the interaction between the structure of the device and the produced reagent primary ion flow.

Moreover, the device may comprise also an outlet channel 110 at the downstream portion of the device for removing the excess flow before the detector to be coupled with the device. The device may also comprise an adjusting means (not shown) for adjusting the flow rates of sample gas flow, candidate reagent gas flow and/or the sheath flow; as well as adjusting means for adjusting the current and/or voltage of the used X-ray source.

The invention has been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims. For example the interaction between the reagent primary ions and particles of the sample gas flow may be a proton transfer, electron transfer reaction, or clustering with primary ion without proton/electron transfer.

1. A method for ionizing particles of a sample gas flow by an ionizer, wherein the particles comprise molecules or clusters and the method comprises following steps:
providing the sample gas flow to flow through an interaction region,
producing reagent primary ions from particles of candidate reagent gas flow,
introducing said reagent primary ions with the sample gas flow in said interaction region in order to arrange interaction between the reagent ions and the particles of the sample gas flow, thereby producing sample gas ions to be delivered to a detector, wherein
said reagent ions are produced by ionising said particles of the candidate reagent gas flow using soft X-ray radiation from a non-radioactive X-ray source.

2. The method according to claim 1, wherein the energy of the used soft X-ray photons is in a range of 1-10 keV, or in a range of 1-5 keV.

3. The method according to claim 1, wherein a sheath flow is arranged to flow at least through a primary ion production region or said interaction region between the sample gas flow and structure of said ionizer, and wherein said sheath flow is e.g. clean air or nitrogen, with small amounts of reagent gas molecules, e.g. nitric acid, sulphuric acid, ammonia, amines, alcohols, or acetone.

4. The method according to claim 1, wherein the sample gas flow and candidate reagent gas flow is configured to flow essentially concentrically at the primary ion production regions, or wherein the trajectory of the produced reagent primary ions is configured to bend inward and towards the sample gas flow at the interaction region.

5. The method of claims 4, wherein the trajectory of the produced reagent ions are achieved by using an electric field and/or by using flow current guiding means, such as a deflector, wing or throttle.

6. The method according to claim 1, wherein the candidate reagent gas flow comprises nitrate [NO₃⁻], bisulfate, HSO4−, protonated ammonia, amines, alcohols or acetone, and wherein the sample gas flow comprises H₂SO₄ [Sulfuric acid], MSA [methane sulfonic acid], H₂SO₄+ amine clusters, highly oxidized organic molecules and their clusters.

7. The method according to claim 1, wherein certain candidate reagent gas flow is selected for producing certain reagent primary ions and thereby providing selective compound charging in the interaction region in order to arrange interaction between the reagent ions and certain desired particles of the sample gas flow.

8. The method according to claim 1, wherein a chemical ionization process is implemented essentially at atmospheric pressure.

9. A device for ionizing particles of a sample gas flow, the particles comprising molecules or clusters, wherein the device comprises:
a first flow tube for providing the sample gas flow,
a generator for producing reagent primary ions from particles of candidate reagent gas flow essentially at a primary ion production region,
an interaction region for introducing said reagent ions into the sample gas flow in order to arrange interaction between the reagent primary ions and the particles of the sample gas flow, thereby producing sample gas ions to be delivered to a detector, wherein
the generator for producing reagent primary ions by ionising said particles of the candidate reagent gas flow is a non-radioactive soft X-ray radiation source.

10. The device of claim 9, wherein the energy of the used soft X-ray photons is in a range of 1-10 keV, most advantageously about 1-5 keV, and wherein said X-ray radiation source is configured to be switched in operation mode and off mode.

11. The device of claim 9, wherein the device comprises also a second flow tube for guiding the candidate reagent gas flow for interaction with the soft X-ray radiation essentially at the primary ion production region, or for guiding the produced reagent primary ions.

12. The device of claim 9, wherein said first and second tubes are arranged essentially concentrically to configure said sample gas flow and candidate reagent gas flow to flow essentially concentrically at the primary ion production region.

13. The device of claim 9, wherein the device comprises a shielded area between the X-ray source and the flowing media, where said shielded area comprises beryllium, aluminium or glass.

14. The device of claim 9, wherein the device is configured to bend the trajectory of the produced reagent primary ions inward and towards the sample gas flow by the means of electrode and/or a flow current guiding means, such as a deflector, wing or throttle.

15. The device of claim 9, wherein the device comprises a laminarizer for producing an essentially laminar sheath flow between the reagent primary ion flow and structure of said device or said second tube.

16. The device of claim 9, wherein the device comprises an outlet channel at the downstream portion of the device for removing the excess flow before the detector to be coupled with the device.

17. The device of claim 9, wherein the device comprises adjusting means for adjusting the flow rates of sample gas flow, candidate reagent gas flow and sheath flow; and/or adjusting the current and/or voltage of the used soft X-ray source.

18. The device of claim 9, wherein at least portion of the second flow tube comprises or functions as an electrode and is configured to bend the trajectory of the produced reagent ions inward and towards the sample gas flow, wherein the voltage difference between the second flow tube and the device outer wall or the first flow tube is applied.
